(19) United States
(12) Patent Application Publication
(10) Pub. No.: US 2016/0166079 A1
(43) Pub. Date: Jun. 16, 2016

(54) INFLATION DEVICE FOR AN INFLATABLE MATTRESS

(71) Applicant: DONGGUAN TIGER POINT, METAL & PLASTIC PRODUCTS CO., TLD., Dongguan City (CN)

(72) Inventor: Chun-Chung TSAI, Dongguan City (CN)

(21) Appl. No.: 14/571,602

(22) Filed: Dec. 16, 2014

(51) Int. Cl. A47C 31/00; F16K 15/00

(52) U.S. Cl. CPC A47C 31/00; F16K 15/00

(57) ABSTRACT

An inflation device has a housing, a check valve assembly, and a filtering cover. The check valve assembly is mounted inside the housing by threads, and the filtering cover covers an external wall of the housing. The check valve assembly has a body, a valve stem, a plate, a spring, and a first gasket. With resilience of the spring, the valve stem, the plate and the first gasket move axially inside the body for opening or closing the check valve assembly. The filtering cover prevents an inflatable mattress from air leakage caused by fiber blocking the check valve assembly. The filtering cover is detachably mounted in the housing for assembling flexibility according to demand. Since the diameter of each hole of the filtering cover is less than 2 mm, the fibers cannot pass through the holes to enter a passage of the body.

### BACKGROUND OF THE INVENTION

1. Field of the Invention

The present invention relates to an inflation device, and more particularly to an inflation device that is mounted in an inflatable mattress to keep air-tightness of the inflatable mattress.

2. Description of the Related Art

With reference to FIGS. 8 and 9, a conventional inflatable mattress 700 has an inflation device 800. The inflatable mattress 700 is formed with plastic sheets 701. Inner walls of the plastic sheets 701 have fibers 702. The inflation device 800 is mounted in the plastic sheets 701 of the inflatable mattress 700 for charging air or discharging air. The property of the inflation device 800 affects the air-tightness of the inflatable mattress 700. For enhancing the stiffness of the inflatable mattress 700, the inner walls of the plastic sheets 701 of the inflatable mattress 700 have the fibers 702 to support the longitudinal structure of the inflatable mattress 700. The inflation device 800 is a check valve which is inserted in the inflatable mattress 700. As inflation is completed and the check valve is closed, the fibers 702 block an air passage of the inflation device 800 with the air stream. The fibers 702 block the air passage and cause the incomplete closure of the inflation device 800, which results in air leakage of the inflatable mattress 700.

With reference to FIG. 10, another conventional inflation device 900 is provided to improve the air leakage by fibers blocking. The inflation device 900 has a bracket 901, a valve 902, a cap 903, an abutting plate 904, a tie 905 and a filter 906. The bracket 901 has a first flange 9011, an annular flange 9012, holes 9013 and an internal thread. The internal thread is formed inside the bracket 901. The valve 902 has an O-ring 9021, a second flange 9022, lateral protrusions 9023 and an external thread. The external thread is formed in an outer wall of the valve 902. The cap 903 has a connecting part 9031. The abutting plate 904 is installed in an external wall of an inflatable mattress. The tie 905 is flexible to stretch and contract. The bracket 901 is installed through the abutting plate 904 and is combined with the valve 902. The connecting part 9031 of the cap 903 is connected with the lateral protrusions 9023 of the valve 902. The cap 903 is linked to the valve 902 with a string. The filter 906 covers an external surface of the bracket 901. An open end of the filter 906 is bound between the first flange 9011 and the annular flange 9012 with the tie 905, the filter 906 covers the holes 9013 to prevent the fiber from passing through the bracket 901 with air stream and blocking the valve 902. However, the filter 906 tends to escape from the external surface of the bracket 901, thereby resulting in the flexibility fatigue of the tie 905 or incorrect assembling on the assembly line.

To overcome the shortcomings, the present invention provides an inflation device with a protrusion of a housing and a filtering cover engaged together to mitigate or obviate the aforementioned problems.

### SUMMARY OF THE INVENTION

The main objective of the present invention is to provide an inflation device which ensures air-tightness of an inflatable mattress by combining a protrusion of a housing and a filtering cover and prevents a check valve assembly from being blocked by fibers.

To achieve the foregoing objective, the inflation device in accordance with the present invention comprises a housing, a check valve assembly, and a filtering cover. The housing has a first passage and a protrusion. The first passage is defined through the housing. The protrusion protrudes from an outer wall of the housing. A check valve assembly is mounted inside the first passage. The filtering cover covers an external wall of the housing. The filtering cover engages with the protrusion.

Other objectives, advantages and novel features of the invention will become more apparent from the following detailed description when taken in conjunction with the accompanying drawings.

### BRIEF DESCRIPTION OF THE DRAWINGS

FIG. 1 is a perspective view of an inflation device for an inflation mattress in accordance with the present invention;

FIG. 2 is a cross sectional side view of the inflation device in FIG. 1;

FIG. 3 is an exploded perspective view of the inflation device in FIG. 1;

FIG. 4 is a perspective view of a housing of the inflation device in FIG. 3;

FIG. 5 is an enlarged top view of a body of a check valve assembly of the inflation device in FIG. 3;

FIG. 6 is a perspective view of a cap of the inflation device in FIG. 3;

FIG. 7 is a top view of the cap of the inflation device in FIG. 6;

FIG. 8 is a perspective view of an inflatable mattress of a conventional inflation device;

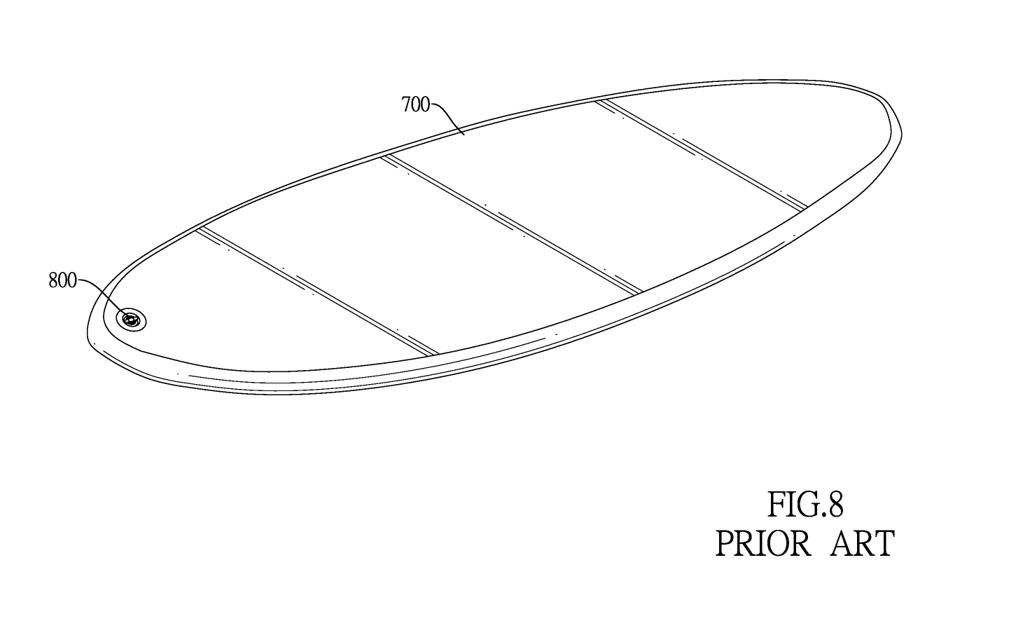

FIG. 9 is an enlarged view of the conventional inflation device mounted in the inflatable mattress in FIG. 8; and

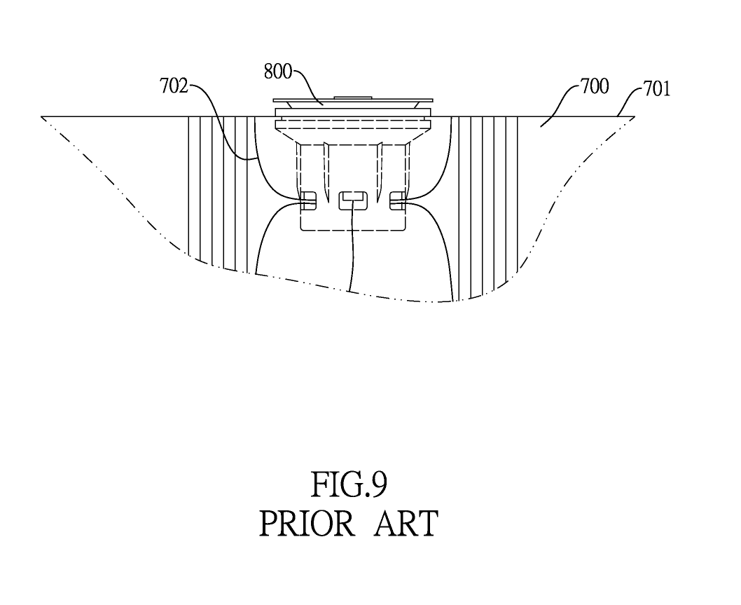

FIG. 10 is an exploded perspective view of another conventional inflation device in FIG. 8.

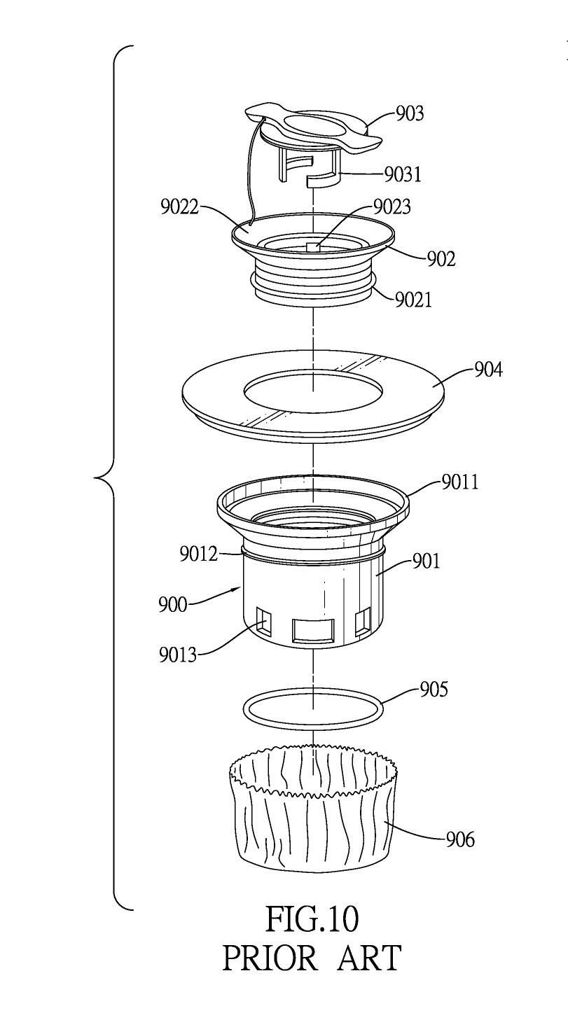

### DETAILED DESCRIPTION OF THE INVENTION

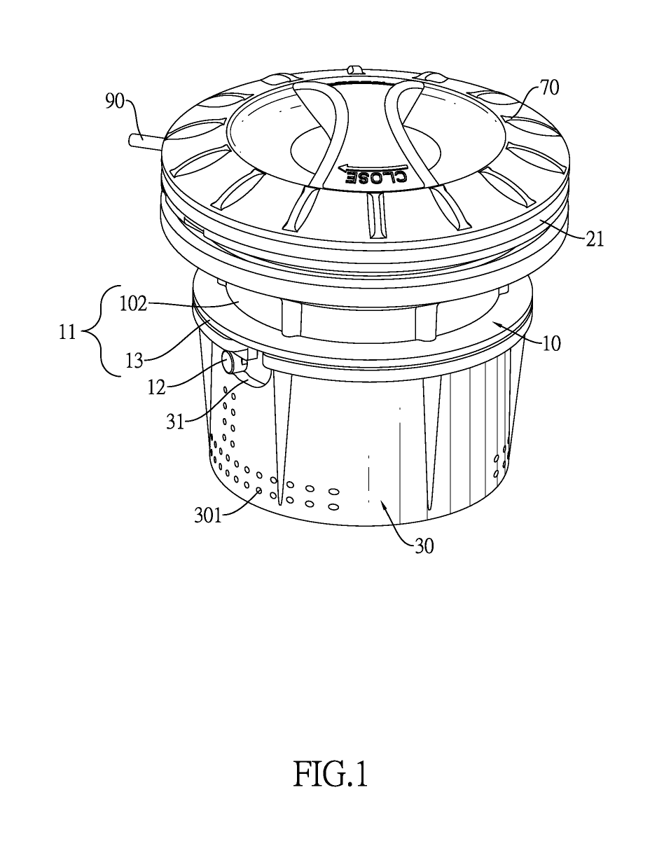

With reference to FIGS. 1 to 3, an inflation device in accordance with the present application comprises a housing 10, a check valve assembly 20, and a filtering cover 30. The inflation device further has a cap 70.

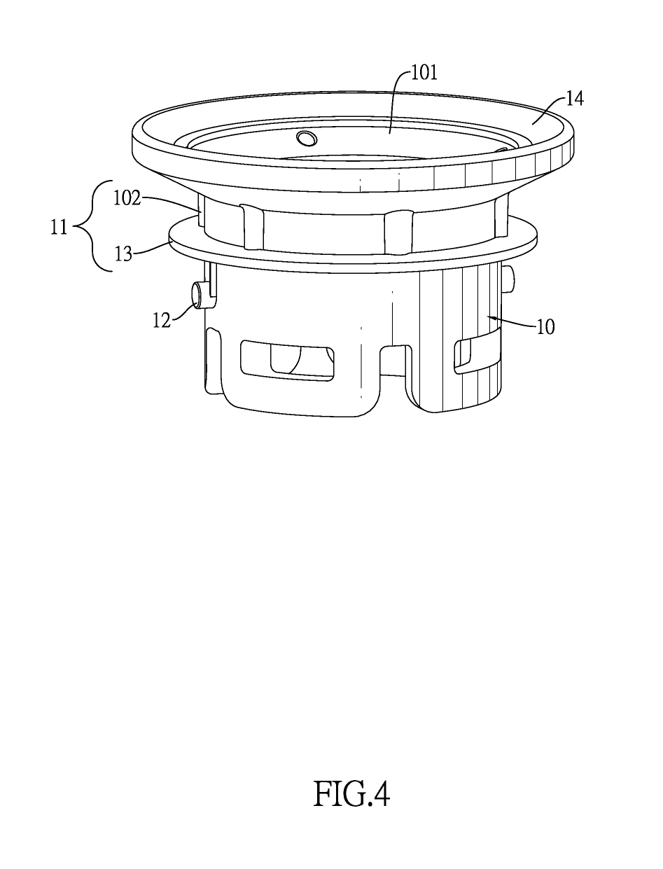

With reference to FIGS. 1 and 4, the housing 10 has a first passage 101, a groove 11, a protrusion 12 and a first abutting flange 14.

The first passage 101 is defined through the housing 10. The groove 11 includes an annular flange 13 and a recess 102. The annular flange 13 protrudes from an outer wall of the housing 10. The first abutting flange 14 is formed in one end of the housing 10. The recess 102 is defined between one side of the annular flange 13 and the first abutting flange 14. The protrusion 12 is defined in the other side of the annular flange 13 and protrudes from the outer wall of the housing 10. The protrusion 12 may be two humps which protrude respectively from the outer wall of the housing 10. Furthermore, the first passage 101 has an internal thread formed in an inner wall of the first passage 101.

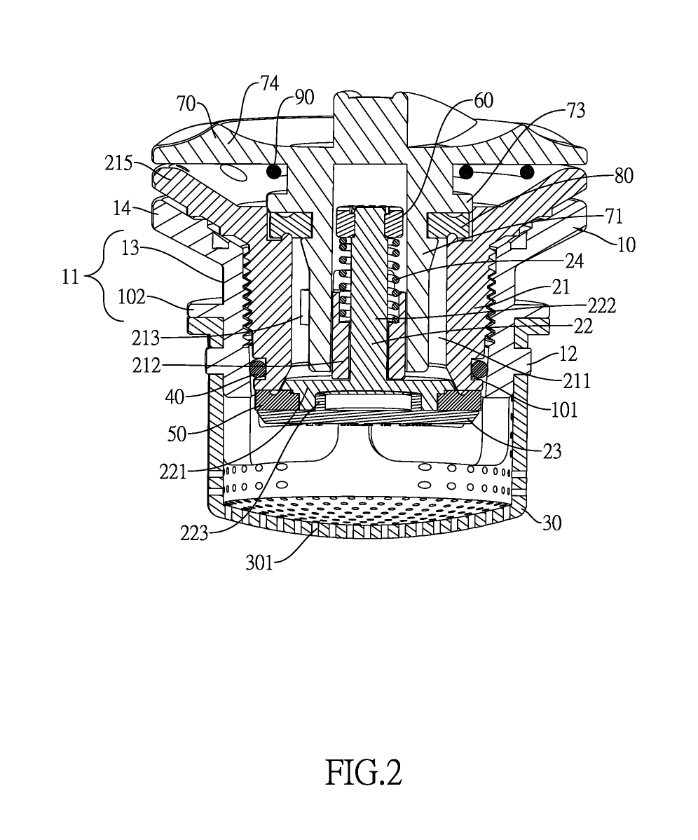

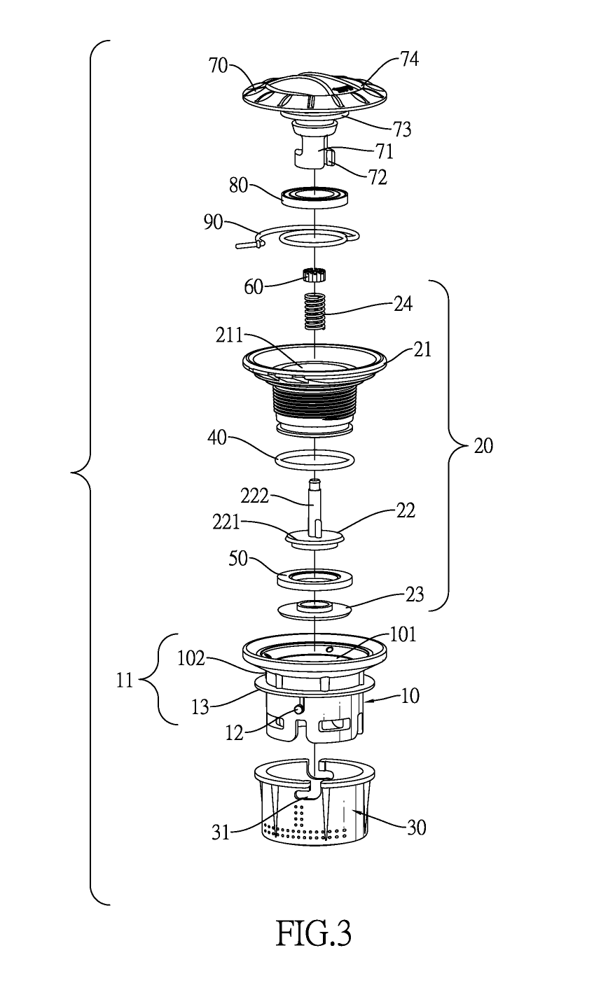

With reference to FIGS. 2 and 3, the check valve assembly 20 has a body 21, a valve stem 22, a plate 23 and a spring 24. The check valve assembly 20 further has an O-ring 40, a first gasket 50 and a retainer 60.

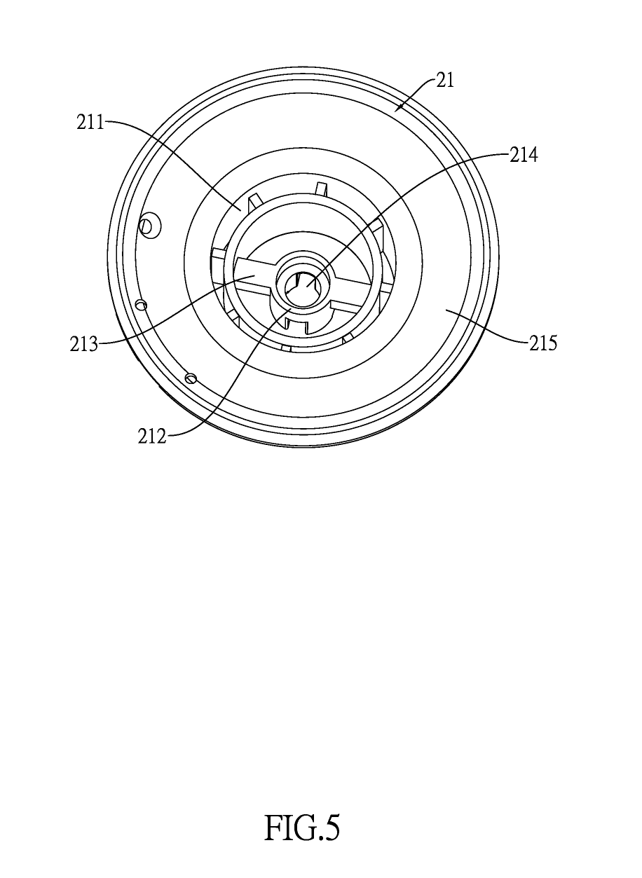

With further reference to FIGS. 2 and 5, the body 21 is mounted inside the housing 10. The body 21 has a second passage 211, a mounting seat 212, ribs 213, a mounting hole 214, a second abutting flange 215 and an external thread.

The second passage 211 is defined though the body 21. The mounting seat 212 is formed at an inner wall of the second passage 211. The ribs 213 are formed at an outer wall of the mounting seat 212. The mounting hole 214 is formed through the mounting seat 212. The second abutting flange 215 is formed at one end of the body 21. The external thread is formed in an outer wall of the body 21.

The body 21 is mounted inside the housing 10 by threading together the external thread of the outer wall of the body 21 and the internal thread of the inner wall of the first passage 101.

The valve stem 22 has a base 221, a rod 222 and a recess 223. An end of the rod 222 protrudes axially from one end surface of the base 221. The recess 223 is formed in the other end surface of the base 221. The rod 222 is mounted through the mounting hole 214 of the mounting seat 212. The rod 222 is mounted inside the body 21.

The plate 23 is mounted in the recess 223 of the valve stem 22.

The spring 24 is mounted around the rod 222 of the valve stem 22.

The O-ring 40 is mounted around the body 21. The O-ring 40 air-tightly abuts an inner wall of the housing 10 and the outer wall of the body 21.

The first gasket 50 is mounted between the base 221 of the valve stem 22 and the plate 23. The first gasket 50 abuts the body 21 to close the second passage 211.

The retainer 60 is mounted at the other end of the rod 222 of the valve stem 22. The retainer 60 and the mounting seat 212 restrain the spring 24.

The filtering cover 30 is detachably mounted in the housing 10. The filtering cover 30 has two first slots 31 and multiple holes 301. The filtering cover 30 is a bowl-like object. One end of the filtering cover 30 is closed and the other end is open. The first slots 31 are formed at the open end of the filtering cover 30 and are spaced at intervals. The holes 301 are defined in the closed end and a side wall of the filtering cover 30. The diameter of each hole 301 is less than 2 mm.

The filtering cover 30 is mounted in the outer wall of the housing 10 by engaging the first slots 31 of the filtering cover 30 with the protrusions 12 respectively.

The cap 70 covers the body 21. The cap 70 has a connecting protrusion 71, two second slots 72, a stop part 73 and a top plate 74. The cap 70 further has a second gasket 80 and a tie 90.

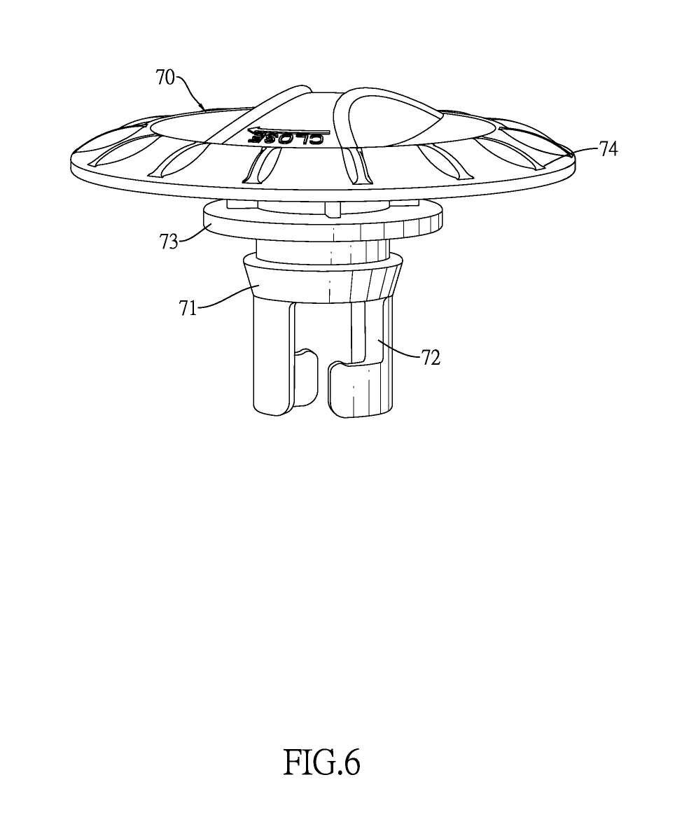

With reference to FIGS. 2, 3 and 6, the connecting protrusion 71 is formed in the top plate 74. The second slots 72 are defined in the connecting protrusion 71 respectively. The stop part 73 is formed in an outer wall of the connecting protrusion 71. The second gasket 80 is mounted around the connecting protrusion 71. The second gasket 80 abuts the stop part 73 and the body 21. The tie 90 is attached to the connecting protrusion 71 and the body 21.

The cap 70 is mounted in the body 21 by engaging the second slots 72 with the ribs 213 of the body 21 respectively.

When the body 21 is threaded on the housing 10, the first abutting flange 14 of the housing 10 and the second abutting flange 215 of the body 21 abut plastic sheet of an inflatable mattress.

When the inflatable mattress is inflated, the air stream pressure pushes the valve stem 22 of the check valve assembly 20 downwards to overcome the resilience of the spring 24, which results in the air stream entering the inflatable mattress. When the inflation is completed, the spring 24 recovers to its original state by resilience and makes the valve stem 22 and the plate 23 axially move upwards. The first gasket 50 moves with the valve stem 22 and the plate 23 to abut the body 21 for closing the second passage 211. As the second passage 211 is closed, the filtering cover 30 stops the fibers from entering the second passage 211 with the air stream.

The filtering cover 30 prevents the inflatable mattress from air leakage caused by the fiber blocking the check valve assembly 20. The filtering cover 30 is detachably mounted in the protrusion 12 of the housing 10. When the inner wall of the inflatable mattress has no fibers, the staff in assembly line could alternatively assemble the inflation device without the filtering cover 30. Since the diameter of each hole 301 is less than 2 mm, the fibers cannot pass through the holes 301 of the filtering cover 30 to enter the second passage 211 of the body 21.

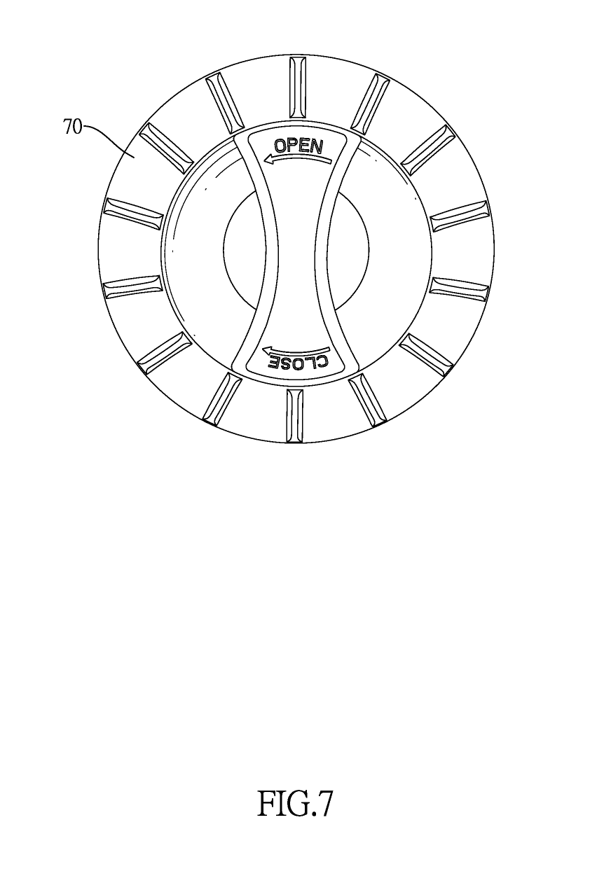

The cap 70 covers the second passage 211 of the body 21 to prevent the valve stem 22 from being pressed unintentionally by assembly staff or users. With reference to FIG. 7, the cap 70 has marks “open” and “close” on top of the cap 70 to indicate the operating direction. When a user is to remove the cap 70 from the body 21, the user just rotates the cap 70 towards the “open” direction to detach the second slots 72 and the ribs 213 from each other. The tie 90 connects the cap 70 and the body 21 to avoid losing the cap 70 when the cap 70 is removed from the body 21.

Even though numerous characteristics and advantages of the present invention have been set forth in the foregoing description, together with details of the structure and function of the invention, the disclosure is illustrative only. Changes may be made in detail, especially in matters of shape, size, and arrangement of parts within the principles of the invention to the full extent indicated by the broad general meaning of the terms in which the appended claims are expressed.

What is claimed is:

1. An inflation device comprising:
a housing having
a first passage defined through the housing; and
a protrusion protruding from an outer wall of the housing;
a check valve assembly mounted inside the first passage; and
a filtering cover covering an external wall of the housing and engaging with the protrusion of the housing.

2. The inflation device as claimed in claim 1, wherein
the protrusion is two humps protruding respectively from the outer wall of the housing; and
the filtering cover has two first slots and is mounted in the outer wall of the housing by engaging with the first slots and the humps respectively.

3. The inflation device as claimed in claim 2, wherein
the filtering cover is a bowl-like object;
one end of the filtering cover is closed and the other end of the filtering cover is open; and
the filtering cover has holes defined in the closed end and a side wall of the filtering cover.

4. The inflation device as claimed in claim 3, wherein
the diameter of each hole is less than 2 mm.

5. The inflation device as claimed in claim 4, wherein
the check valve assembly has
a body mounted inside the first passage of the housing and having a second passage defined though the body;
a valve stem having
a base;
a rod mounted inside the body and protruding axially from one end surface of the base; and
a recess formed in the base;
a plate mounted in the recess of the valve stem;
a spring mounted around the rod of the valve stem; and
a first gasket mounted between the base of the valve stem and the plate and abutting the body.

6. The inflation device as claimed in claim 5, wherein
the check valve assembly further has a retainer mounted in the rod of the valve stem;
the body has
a mounting seat formed at an inner wall of the second passage;
a mounting hole formed through the mounting seat;
the rod of the valve stem is mounted through the mounting hole of the mounting seat;
the retainer is mounted in the rod of the valve stem; and
the spring is mounted around the rod and abuts the mounting seat of the body and the retainer.

7. The inflation device as claimed in claim 6, wherein
the check valve assembly further has an O-ring;
the body has an external thread formed in an outer wall of the body;
the housing has an internal thread formed in an inner wall of the first passage;
the body is mounted inside the housing by threading together the external thread of the outer wall of the body and the internal thread of the inner wall of the first passage;
the O-ring airtightly abuts an inner wall of the housing and the outer wall of the body.

8. The inflation device as claimed in claim 7, wherein the inflation device further has a cap;
the cap has
a top plate;
a connecting protrusion formed in the top plate; and
two second slots defined in the connecting protrusion respectively;
the body further has ribs formed at an outer wall of the mounting seat; and
the cap covers the body by engaging the second slots with the ribs of the body respectively.

9. The inflation device as claimed in claim 8, wherein
the cap further has
a stop part formed in an outer wall of the connecting protrusion; and
a second gasket mounted around the connecting protrusion and abutting the connecting protrusion and the body.

10. The inflation device as claimed in claim 9, wherein
the cap further has a tie attached to the connecting protrusion of the cap and the body respectively.
